(19) United States
(12) Patent Application Publication
(10) Pub. No.: US 2003/0191715 A1
(43) Pub. Date: Oct. 9, 2003

(54) Secured purchase transaction

(76) Inventor: John Pinizzotto, East Meadow, NY (US)

Correspondence Address: Lloyd McAulay, Reed Smith LLP, 599 Lexington Avenue, New York, NY, 10022-7650, US

(21) Appl. No.: 10/400,102

(22) Filed: Mar. 26, 2003

Related U.S. Application Data
(63) Continuation-in-part of application No. 09/534,681, filed on Mar. 24, 2000, now abandoned.

(51) Int. Cl. G06F 17/60

(52) U.S. Cl. 705/44

(57) ABSTRACT

A secure Internet transaction processing system in which individual ones of a plurality of customers order from a targeted one of a plurality of merchants through a processing center. The purchaser's purchase card data together with the purchaser's personal identification data (e.g. personal identification code or signature) is encrypted at the customer ordering terminal and sent to the processing center over the Internet where it is decrypted for the purpose of undertaking a standard procedure to verify payment capability. The order is then placed by the processing center, together with payment capability confirmation, over the Internet with the targeted merchant thereby avoiding access at the merchant's station to the customer's purchase card or check identification numbers and personal identification data.

### REFERENCE TO RELATED APPLICATIONS

This application is a continuation-in-part of patent application Ser. No. 09/534,681 filed Mar. 24, 2000 and entitled: Secured Purchase Card Transaction.

### BACKGROUND OF THE INVENTION

The potential hazard of a security breach in the use of a debit card or a credit card from home for ordering goods or services over the Internet is a problem that inhibits the use of purchase cards (that is, credit cards and debit cards). The security problem is particularly severe when it comes to the risks that customers have in the use of debit cards. There appears to be no existing home customer terminals through which a purchase card may be swiped to effect a purchase of goods or services from a merchant or to provide payment for ongoing services.

When a purchase card is used from home for an Internet purchase, the customer enters the card number through the computer keyboard. The card number is then directly available to the merchant and available to one who can hack the merchant's list. Unfortunately, credit card fraud is common. The regulations and business practice tend to impose the loss on the merchant or the financial institution that processes the merchant's account. Current regulations put a debit cardholder at great risk. The entire balance in the bank of a debit card holder may be at risk.

Many small and medium size merchants are reluctant to sell over the Internet because of the lack of assured payment. The credit card mode of payment does not result in a final sale. The customer has the opportunity to change his or her mind. The use of debit cards would overcome that problem. But, because of the lack of security on the Internet, pin based debit cards are not widely used. There appears to be no effort now being made to provide this debit card service to the smaller merchants.

More recently, check accounting systems have been employed to permit the use of a check in a fashion analogous to the use of a debit card. The limitations and risks in a check accounting system for Internet purchase purposes are similar to the limitations and risks in the use of a debit card for Internet marketing.

Accordingly, a major purpose of this invention is to provide a secure Internet marketing system for use of purchase cards such as credit cards or debit cards and for use of checks.

It is a related purpose of this invention to facilitate merchant payment and to encourage merchant willingness to become part of Internet commerce.

### BRIEF DESCRIPTION

In brief, the embodiment illustrated is a secured purchase document transaction system in which a large number of customer ordering terminals are involved as well as a large number of merchant stations. For each customer ordering terminal, there is a facility for a purchase card swipe or for check scanning or both to obtain the card number or check account and routing numbers. There is also either a keypad or the like to permit entering a purchaser identification code (PIC) or an electronic signature encoder. At each customer ordering terminal, there is an encryption module which encrypts the swiped purchase card number or check number as well as the PIC or signature encoder. This encrypted information is entered into the customer's personal computer. Then the encrypted information, together with the customer ordering information identifying a merchant and a product, is sent over the Internet by the personal computer to a processing center.

There may be a PIC entry through a keypad or a signature entry mechanism through a known type of electronic signature pad. Depending upon the circumstance and installation, there may be one or the other or both of these identification input devices.

Associated with each customer ordering terminal, is an encryption module which encrypts the purchase card number or check number as well as the PIC number or signature.

At the processing center, the debit or credit payment capability is confirmed in a standard fashion with appropriate bank and credit card companies. When confirmation is obtained, the processing center prepares appropriate information for a merchant including details of the purchase order and a report verifying customer payment capability. This information is then sent over the Internet to the merchant targeted by the customer order. The processing center does not send any sensitive customer information to the merchant. Thus credit card number, debit card number, account number, purchaser identification number and signature are retained secure at the processing center.

The processing center also prepares a purchase verification notice to the customer which is sent over the Internet to the customer originating the order. Where debit cards or checks are used and the payment is received from a bank, the processing center provides a financial holding center to hold the payment for the targeted merchant.

### BRIEF DESCRIPTION OF THE DRAWINGS

FIG. 1 is a high level block arrangement illustrating the system of this invention and particularly illustrates the relationship of the processing center to the customer and the merchant.

FIG. 2 is a block flow diagram illustrating the system of this invention in relationship to one customer ordering encryption terminal purchasing from a particular merchant.

FIG. 3 is a block diagram of a first embodiment of a customer ordering encryption terminal employing a purchase card swipe and a PIC entry keypad.

FIG. 4 is a block diagram of a second embodiment of a customer ordering encryption terminal employing a purchase card swipe and a signature identification pad.

FIG. 5 is a block diagram of a third embodiment of a customer ordering encryption terminal employing a check data reader and a PIC entry keypad.

FIG. 6 is a block diagram of a fourth embodiment of a customer ordering encryption terminal employing a check data reader and a signature identification pad.

FIG. 7 is a flow chart illustrating operation of the system of this invention.

### DESCRIPTION OF THE PREFERRED EMBODIMENTS

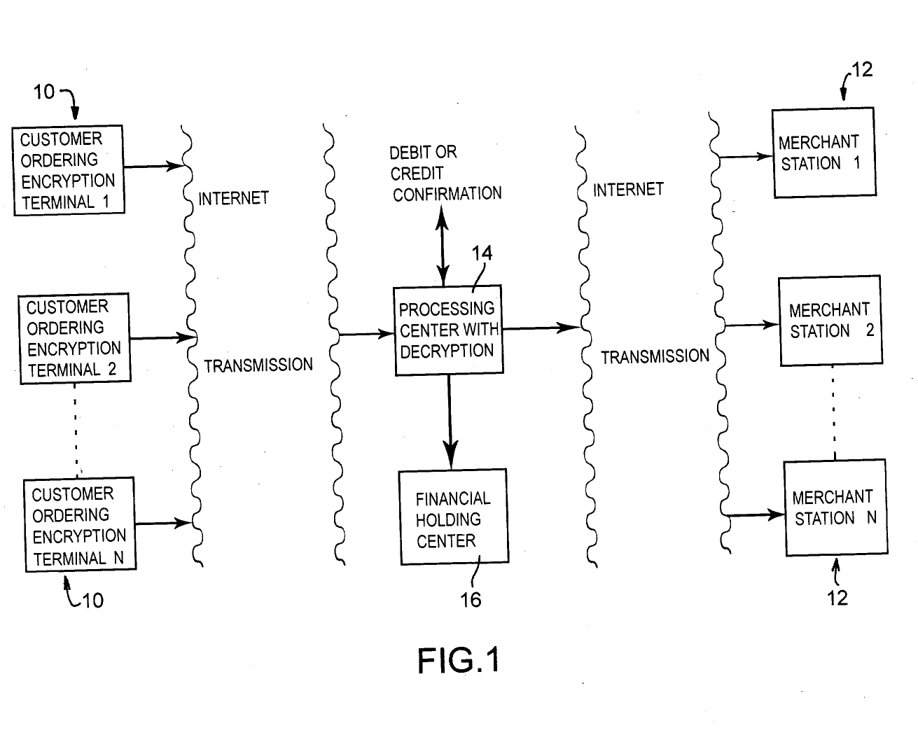

FIG. 1 illustrates the system of this invention in which a plurality of customers have encryption terminals 10 such as terminals 1, 2 . . . N.

In addition, there are a plurality of merchant stations 12 represented by the merchant stations 1, 2 . . . N.

A processing center 14 is at the heart of the communication between the customer terminals 10 and the merchant stations 12. This processing center 14 is central to the security provided to each customer 10 and the assurance of payment provided to each merchant 12. As indicated in FIG. 1, Internet transmission is employed to provide communication between a plurality of customers and a plurality of merchants.

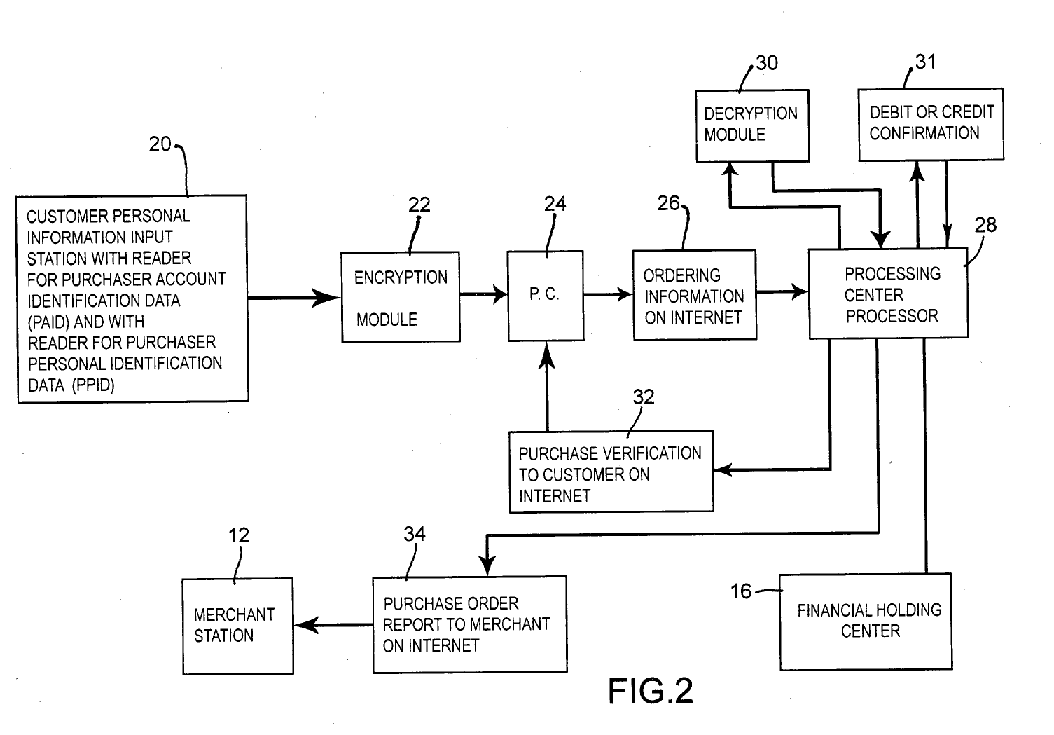

As shown in any of FIGS. 2 through 6, security is provided by an arrangement within each customer ordering encryption terminal 10 such that the personal identification information is encrypted by an encryption module 22 prior to being entered into the memory of the personal computer 24. This assures that any hacking through to the personal computer 24 will not compromise the integrity of the terminal 10 and will not be able to reach the unencrypted personal information. This personal information is discussed below.

The encrypted information can be decrypted only at the processing center 14. The processing center 14, with the decrypted information, obtains credit or debit information on the particular customer. Where the customer is using a debit card or check, the information can include bank confirmation that the amounts involved are in the customer's bank account. The system provides the capability to transfer the amount involved to a financial holding center 16 for the merchant; which holding center is under the control of the processing center 14.

Once the credit information or debit information has been confirmed, the processing center 14 then sends an appropriate statement to the designated merchant station 12 over the Internet and provides the merchant with information as to what has been ordered, identifying the customer and confirming that payment or credit has been made or is available.

None of the merchant stations 12 receive the credit card number or debit card number or PIC number or check identification numbers or signature. The merchant stations 12 do not even receive an encryption of this data.

As shown in FIG. 2, each customer terminal 10 includes a personal customer information input station 20. This station 20 includes a card swipe and/or check data reader to accept purchaser account identification data (PAID) which can either be a credit card or a debit card or a check. This customer input station 20 also includes a purchaser personal identification data (PPID) reader which can be either or both of: (i) a keypad or the like for the entering of a personal identification code (PIC), and (ii) an electronic signature pad. The personal data entered at each personal customer information input station 20 is fed to an encryption module 22 that is used to encrypt the card or check identification data of the PIC number and/or signature; that is, encrypt the PAID and PPID. It is the encrypted purchaser identification information which is loaded into the PC 24.

As used herein, the term “purchase document” includes a credit card, or a debit card or a check.

When the purchase document is a credit card, the card number will be swiped through a reader at the station 20 and that information will be encrypted by the module 24.

Where the purchase document is a debt card, the customer ordering station 20 swipe will detect the card number and the customer ordering station will have a keypad or other similar means for the debit card owner to insert their personal identification code (PIC). The encryption module 22 will encrypt both the debit card identification number and the PIN.

Where the purchase document is a check, the customer ordering station 20 will have a check scan device to detect the account number and routing number. The customer ordering station has a keypad for the check owner to insert their PIC. The encryption module 22 will encrypt both the PIC and the check numbers.

An electronic signature reading pad can be used instead of (or in addition) to the keypad for insertion of a PIC.

The customer terminal 10, after encryption of the personal information by the module 22 enters the encrypted information into the customer's personal computer 24. The computer 24 then sends out the ordering information on the Internet as indicated at 26; which ordering information includes the encrypted purchaser account information data (PAID) and encrypted purchaser personal identification data (PPID). This ordering information is received at the processing center's processor 28. The processing center 14 includes a decryption module 30 for decrypting the PAID and PPID.

The processor 28 at the center 14, as indicated at 31, makes an appropriate inquiry of a bank or credit processing station concerning the availability of the funds in the bank for a debit card or check or the credit available for a credit card. The processor 28 then receives confirmation from the bank or the credit station.

After the processor 28 receives the bank or credit confirmation, the processor 28 generates a purchase verification to the customer, as indicated at 32, which is sent over the Internet to the customer. The processor 28 also generates a purchase order and report to the merchant, as indicated at 34, which is sent to the designated merchant station 12. The report to the merchant provides the merchant with two essential types of information. The first is an identification of the customer and of the item or service being ordered. The second is verification of a bank payment to cover a debit card or check or verification of credit availability to cover a credit card.

The system may also provide a financial holding center 16 in which the amounts being transferred by a debit card or check from a bank for a merchant may be held for the merchant.

The stage where the processor 28 makes inquiry, to determine if debit card funds or check funds are available or if credit is available and to receive information concerning such, is a known processing stage that is currently undertaken by merchants and/or banks that accept credit cards and/or debit cards. Accordingly, there is no need to go into a discussion of the verification processing. It might be noted that there is a forty-eight hour hold put on the transfer of debit card funds.

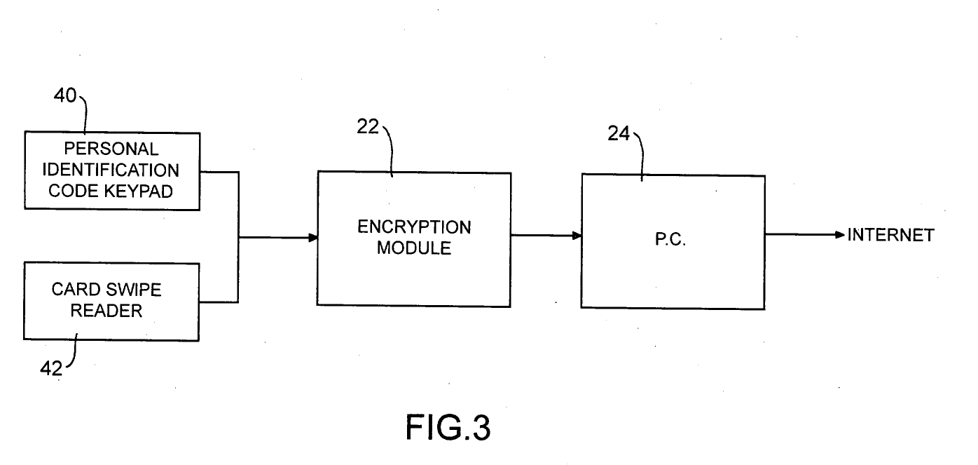

In the FIG. 3 embodiment, the customer encryption terminal is essentially a keypad 40 and a card reader 42, both of which provide inputs to the encryption module 22. The output of the encryption module 22 is applied to the personal computer (PC) 24 for transmission over the Internet. In the FIG. 3 embodiment, the encryption module 22 will have to provide pass through capability for the keyboard input to the PC. In that embodiment, the encryption module 22 would therefore be plugged into the keyboard port of the personal computer. It is presently contemplated that it would be more user friendly to incorporate the encryption module 22 and card swipe reader 42 in a single unit so that the user will simply have to unhook the keyboard from the PC and insert the combined module between keyboard and PC. The encryption module can also be incorporated into the keyboard.

A standard card reader is preferred for reasons of economy and performance. The encryption module 22 itself can employ any one of a number of known encryption algorithms appropriate to the level of security desired for the system.

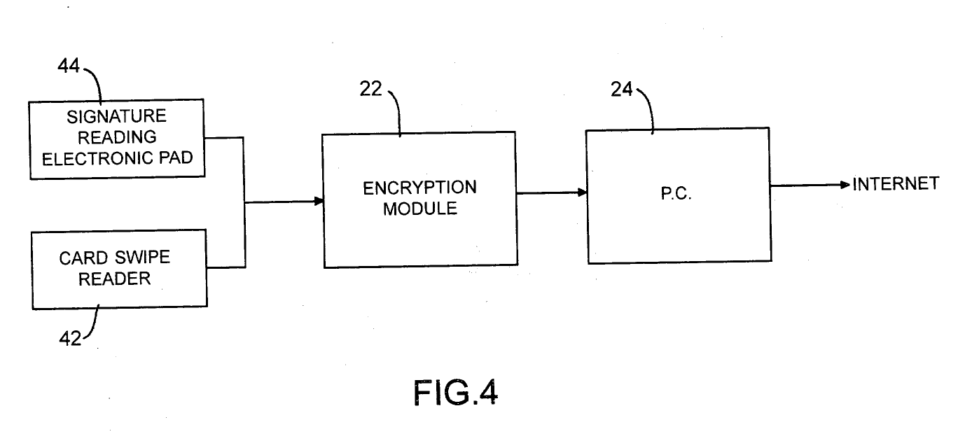

FIG. 4 illustrates an embodiment in which an electronic signature pad 44 is employed in lieu of the PIC keypad 40. Electronic pads that encode a signature for transmission and confirmation are a known type of product. A signature pad 44 can be used in lieu of the PIC keypad 40 or, if security requirements are severe enough, in addition to the PIC keypad 40.

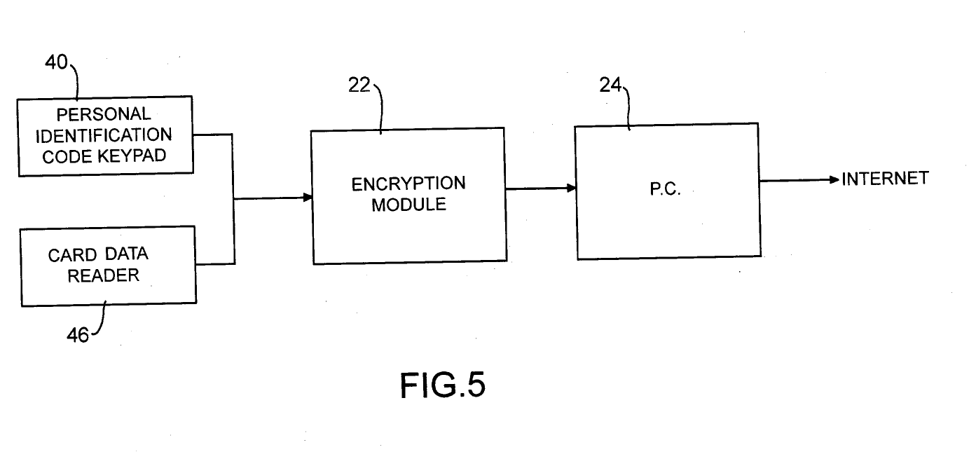

FIG. 5 illustrates a further embodiment of the customer ordering encryption terminal 10 in which a check data reader 46 is used in lieu of the purchase card reader 42. Check data readers are known types of equipment which basically read the account number and the bank routing identification, normally found at the lower left-hand margin of the check.

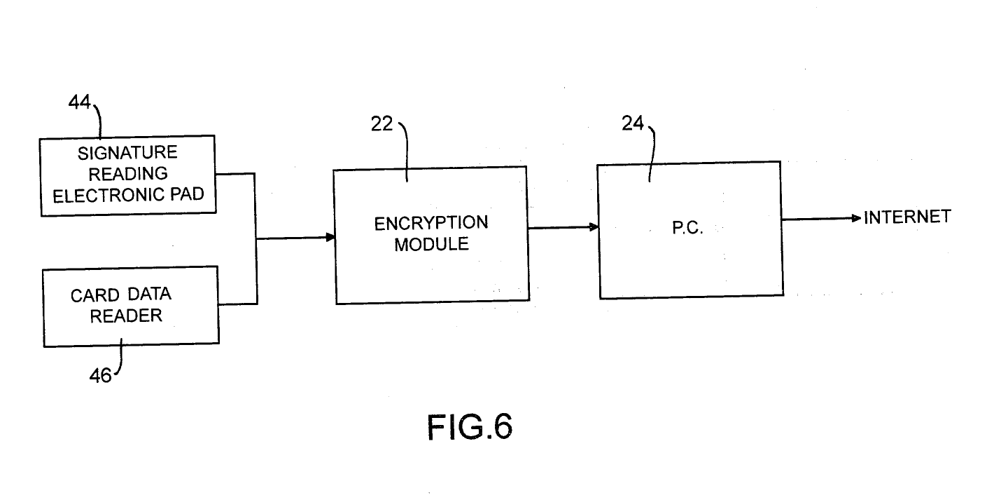

FIG. 6 is a fourth embodiment in which the check data reader 46 of the FIG. 5 embodiment is employed in connection with the electronic signature pad 44 feature of the FIG. 4 embodiment.

Although not shown, it should be noted that in order to use a standard PC, there will be the need to employ a CD ROM input to the PC in order to provide appropriate directories and, most importantly, to provide a predetermined screen display interface with the customer.

The transmission and reception of information over the Internet requires only known types of modem and other equipment as a component of the terminals 10, processing center 14 and merchant stations 12 and thus are not described in any detail herein.

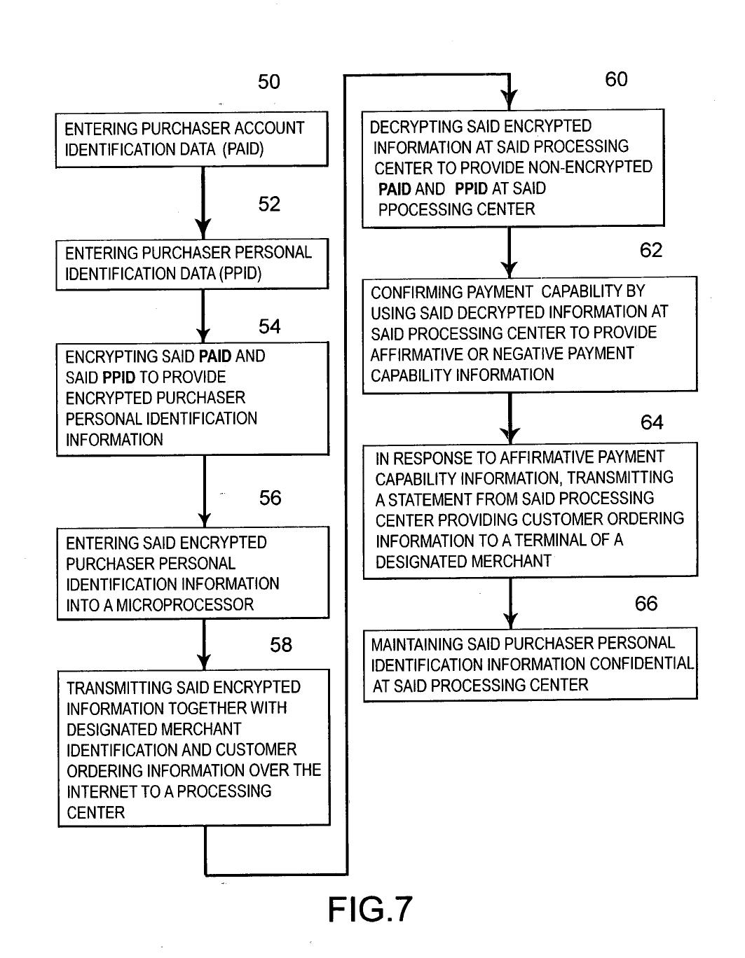

FIG. 7 illustrates the transactional method that is performed by the system shown in FIGS. 1 through 6. The first two steps are for the purchaser to enter the purchaser's personal identification information. This includes entering the purchaser account identification data (PAID) at step 50 and also entering the purchaser personal identification data (PPID) at step 52. These entry steps are made at the customer ordering terminal 10 and can employ any of the data entry units 40, 42, 44 and 46 illustrated in FIGS. 3 through 6.

At step 54, the purchaser personal identification information is encrypted and, notably, it is encrypted prior to entry into the personal computer 24 at the customer ordering terminal 10.

At step 56, the purchaser's encrypted personal identification information is entered into a microprocessor such as a personal computer 26.

At step 58, this encrypted purchaser personal identification information is transmitted over the Internet to the processing center 28. This transmission step 58 will normally incorporate the designated merchant's identification and customer ordering information. These two items are provided by the purchaser by entering such into the purchaser's personal computer 26.

At step 60, in the processing center 28, the encrypted information is decrypted to provide unencrypted PAID and PPID at the processing center 28.

At step 62, payment capability of the purchaser is confirmed by using the decrypted information. Thus providing either affirmative or negative payment capability information.

At step 64, in response to affirmative payment capability information, a statement is transmitted from the processing center 28 to a terminal 36 of a designated merchant. This step 64 provides the merchant with the customer ordering information. Step 64 also affirms ability for payment but does not include the purchaser personal identification information. The latter is maintained confidential at the processing center 28.

Step 66 designates that the preceding step 64 is taken without divulging the customer's personal identification information.

Traditionally, individual customers have gone through a merchant in order to place their order and then the merchant would undertake the validation of the purchase card. As described above, this system decouples the set of customers from the set of merchants as well as decoupling each individual customer from the targeted merchant. The customer's security is greatly enhanced because no amount of hacking at or through a merchant's station would provide the customer's purchaser identification (PII). As a consequence of enhanced customer security, transactions are facilitated or encouraged and customers may find enhanced value in Internet transactions. As a consequence of more assured customer ability to pay, merchants should find enhanced value in Internet transactions.

Definitions

Purchaser Personal Identification Data (PPID)

This application has described the use of a PIC or a signature, through a signature verification pad, as techniques of providing the needed personal identification. It should be understood that any individual biometric record or any other input under the control of the purchaser in lieu of the PIC or signature is an alternate to the specific implementations taught. The term PAID or purchaser personal identification data covers all the varieties of techniques that achieves this function.

Purchase Card

It should be understood that the purchase card can be a credit card, private label card, debit card, gift card or any other card or device which provides the purchaser account identification.

Personal Account Identification Data (PAID)

This personal account identification data or PAID disclosed in this application includes the use of a purchase card swipe or check data reader to obtain the purchaser's account identification data-to determine that the purchaser's account has the required balance or credit for the particular purchase.

Purchaser Identification Information (PII)

The term is used herein to refer to the combined PPID and PAID; both of which are encrypted by the module 44 before being sent over the Internet.

While the foregoing description and drawings represent the presently preferred embodiments of the invention, it should be understood that those skilled in the art will be able to make changes and modifications to those embodiments without departing from the teachings of the invention and the scope of the claims.

For example, it is the processing center 14 and the manner in which it operates as an information traffic control that provides the advantages of this invention; and in particular, the advantage of enhanced security to the purchaser coupled with enhanced assurance of payment to the merchant.

Accordingly, it would be possible in a system incorporating the key features of this invention to dispense with the reader for purchaser personal identification data (PPID) in the customer ordering terminal 20. Although this would not be a preferred embodiment, it must be understood that the inventive concept subsumes such an embodiment.

What is claimed is:

1. A secured purchase transaction system comprising:
a plurality of customer ordering terminals, each of said terminals having a purchaser account identification data reader and a purchaser personal identification data entry means,
an encryption module at each of said customer ordering terminals to encrypt purchaser account identification data and purchaser personal identification data to thereby provide encrypted personal identification information,
a microprocessor at each of said customer ordering terminals coupled to the output of said encryption module to couple said encrypted personal identification information to the Internet,
a processing center,
means to transmit customer ordering information including said encrypted personal identification information, from said microprocessor over the Internet, to said processing center,
the customer ordering information including a designated merchant identification,
a decryption module at said processing center, said decryption module providing the purchaser account identification data and purchaser personal identification data,
whereby said processing center can confirm payment capability,
said processing center, in response to payment capability confirmation, generating a first statement to the designated merchant providing said customer ordering information and to confirm purchaser payment capability,
a plurality of merchant stations, each of said merchant stations corresponding to a separate designated merchant, each of said stations adapted to receive said first statement addressed to the designated merchant, and
means at said processing center to transmit said first statement to the designated merchant over the Internet,
said processing center maintaining said purchaser account identification data and said purchaser personal identification data private from said designated merchant.

2. The system of claim 1 wherein: said processing center generates a purchase verification confirming the placement of the order and transmits said purchase verification to the customer ordering terminal.

3. The system of claim 1 wherein: said purchaser account identification data reader is a purchase card swipe reader and said purchaser personal identification data entering capacity is provided by a personal identification code keypad.

4. The system of claim 1 wherein: said purchaser account identification data reader is a purchase card swipe reader and said purchaser personal identification data entering capacity is provided by an electronic signature reading pad.

5. The system of claim 1 wherein: said purchaser account identification data reader is a check data reader and said purchaser personal identification data entering capacity is provided by an electronic signature reading pad.

6. The system of claim 1 wherein:
said purchaser account identification data reader is a check data reader and said purchaser personal identification data entering capacity is provided by a personal identification code keypad.

7. The system of claim 3 wherein: said purchase card is a debit card and further comprising: a financial holding center for retaining any validated debit card amounts.

8. The system of claim 4 wherein: said purchase card is a debit card and further comprising: a financial holding center for retaining any validated debit card amounts.

9. In a secured purchase transaction system having a plurality of customer ordering terminals and a plurality of merchant stations wherein each of said customer ordering terminals has a purchaser account identification data reader and a purchaser personal identification data entering capacity with an encryption module at each of the terminals to encrypt said identification data to provide encrypted purchaser identification information that is transmitted over the Internet, the sub-system comprising:
a processing center,
receipt means at said processing center to receive customer ordering information from each of said customer ordering terminals together with the encrypted purchaser identification information, each customer ordering information including a designated merchant identification,
a decryption module at said processing center, said decryption module providing said purchaser account information data and said purchaser personal information data,
communication means at said processing center to confirm customer payment capability,
said processing center, in response to customer payment capability confirmation, generating a statement to the designated merchant providing said customer ordering information and confirming payment capability, and
transmitting means at said processing center to transmit said statement to the designated merchant,
said processing center maintaining said purchaser account information data and said purchase personal information data secure from the designated merchant.

10. The system of claim 9 wherein: said purchase card is a debit card and further comprising: a financial holding center for retaining any validated debit card amounts.

11. A secured purchase transaction system comprising:
a plurality of customer ordering terminals, each of said terminals having a purchaser account identification data reader,
a first encryption module at each of said customer ordering terminals to encrypt purchaser account identification data to thereby provide encrypted personal identification information,
a processing center,
means to transmit customer ordering information from each of said ordering terminals, together with said encrypted personal identification information over the Internet, the customer ordering information including a designated merchant identification,
a decryption module at said processing center, said decryption module providing the purchaser account identification data,
whereby said processing center can confirm payment capability,
said processing center, in response to payment capability confirmation, generating a first statement to the designated merchant providing said customer ordering information and to confirm purchaser payment capability,
a plurality of merchant stations, each of said merchant stations corresponding to a separate designated merchant, each of said stations adapted to receive said first statement addressed to the designated merchant, and
means at said processing center to transmit said first statement to the designated merchant over the Internet,
said processing center maintaining said purchaser account identification data private from said designated merchant.

12. The system of claim 11 wherein: said processing center generates a purchase verification confirming the placement of the order and transmits said purchase verification to the customer ordering terminal.

13. The system of claim 11 wherein: said purchaser account identification data reader is a purchase card swipe reader.

14. The system of claim 11 wherein: said purchaser account identification data reader is a check data reader.

15. The system of claim 11 wherein: said purchase card is a debit card and further comprising: a financial holding center for retaining any validated debit card amounts.

16. The method of providing a secured purchase transaction comprising the steps of:
entering purchaser personal identification information including purchaser account identification data and purchaser personal identification data at a data entry station located at a customer ordering terminal,
encrypting said purchaser account identification data and said purchaser personal identification data to provide encrypted purchaser personal identification information,
entering said encrypted purchaser personal identification information into a microprocessor,
transmitting said encrypted information together with designated merchant identification and customer ordering information to a processing center,
decrypting said encrypted information at said processing center to provide said purchaser account identification data and said purchaser personal identification data at said processing center,
confirming payment capability by using said decrypted information at said processing center to provide affirmative or negative payment capability information,
in response to affirmative payment capability information, transmitting a statement from said processing center providing customer ordering information to a terminal of said designated merchant, and
maintaining said purchaser personal identification information confidential at said processing center.

17. The method of claim 16 further comprising the step of:
transmitting a purchase verification confirmation statement to said customer ordering terminal confirming the transmission of said statement to said designated merchant.

18. The method of claim 16 wherein: said purchaser account identification data is entered by swiping a purchase card through a card swipe reader and said purchaser personal identification data is provided by entering said data through a keypad.

19. The method of claim 16 wherein: said purchaser account identification data is entered by swiping a purchase card through a card swipe reader and said purchaser personal identification data entering capacity is provided by electronically reading a signature.

20. The method of claim 16 wherein: said purchaser account identification data is provided by scanning a check with a check data reader and said purchaser personal identification data entering capacity is provided by electronically reading a signature.
